(19) United States
(12) Patent Application Publication
(10) Pub. No.: US 2025/0308553 A1
(43) Pub. Date: Oct. 2, 2025

(54) DATA STORAGE MEDIUM WITH MAGNETOCALORIC LAYER

(71) Applicant: Seagate Technology LLC, Fremont, CA (US)

(72) Inventors: Xiong Liu, Singapore (SG); Barish Chakravarty, Singapore (SG); Lihong Zhang, Singapore (SG)

(21) Appl. No.: 18/623,145

(22) Filed: Apr. 1, 2024

(51) Int. Cl. G11B 5/66; G11B 5/00; G11B 5/012; G11B 5/667

(52) U.S. Cl. CPC G11B 5/672; G11B 5/012; G11B 5/667; G11B 2005/0005

(57) ABSTRACT

A data storage medium includes a cobalt-based ferromagnetic recording layer, a non-magnetic substrate, and a magnetocaloric material. The magnetocaloric material is disposed between the recording layer and the substrate, wherein the magnetocaloric material is configured to generate heat upon exposure to a magnetic field that causes a phase change in the magnetocaloric material. A method of writing data onto a data storage medium includes applying a magnetic field to the data storage medium at a write location from a write head, wherein the data storage medium includes a cobalt-based ferromagnetic recording layer, a non-magnetic substrate, and a magnetocaloric material disposed between the recording layer and the substrate. The method includes transferring heat from the magnetocaloric material to the recording layer; moving the write location out of the magnetic field, wherein the phase change is reversed; and absorbing heat from the recording layer by the magnetocaloric material.

### TECHNICAL FIELD

The disclosure relates to a data storage medium for a hard disc drive. Hard disc drives utilize one or more magnetic recording heads fabricated on sliders to read and write data on magnetic storage media.

### SUMMARY

In one embodiment, a data storage medium comprises a cobalt-based ferromagnetic recording layer, a non-magnetic substrate, and a magnetocaloric material. The magnetocaloric material is disposed between the recording layer and the substrate, wherein the magnetocaloric material is configured to generate heat upon exposure to a magnetic field that causes a phase change in the magnetocaloric material.

In another embodiment, a method of writing data onto a data storage medium comprises applying a magnetic field to the data storage medium at a write location from a write head, wherein the data storage medium comprises a cobalt-based ferromagnetic recording layer, a non-magnetic substrate, and a magnetocaloric material disposed between the recording layer and the substrate. The magnetocaloric material generates heat upon exposure to the magnetic field that causes a phase change in the magnetocaloric material. The method comprises transferring heat from the magnetocaloric material to the recording layer; moving the write location out of the magnetic field, wherein the phase change is reversed; and absorbing heat from the recording layer by the magnetocaloric material.

Other features and benefits that characterize embodiments of the disclosure will be apparent upon reading the following detailed description and review of the associated drawings.

### BRIEF DESCRIPTION OF THE DRAWINGS

FIG. 1 is a schematic illustration of an exemplary data storage device.

FIG. 2 is a side view of a portion of a data storage medium and a recording head, which may be utilized in the disc drive of FIG. 1.

FIG. 3 is a graph illustrating the temperature dependence of coercivity in various cobalt-based thin film recording media.

FIG. 4 is a partial side cross-sectional view of a first embodiment of a recording medium.

FIG. 5 is a partial side cross-sectional view of a second embodiment of a recording medium.

FIG. 6 is a partial side cross-sectional view of a third embodiment of a recording medium.

### DETAILED DESCRIPTION OF ILLUSTRATIVE EMBODIMENTS

Magnetized media are widely used in various applications, particularly in the computer industry for data storage and retrieval applications, as well as for storage of audio and video signals. Disc drive memory systems store digital information that is recorded on concentric tracks on a magnetic disc medium. At least one disc is rotatably mounted on a spindle, and the information, which can be stored in the form of magnetic transitions within the discs, is accessed using read/write heads or transducers. A drive controller is typically used for controlling the disc drive system based on commands received from a host system. The drive controller controls the disc drive to store and retrieve information from the magnetic discs.

Magnetic thin-film media, wherein a fine grained polycrystalline magnetic alloy layer serves as the active recording medium layer, are generally classified as “longitudinal” or “perpendicular,” depending on the orientation of the magnetization of the magnetic domains of the grains of the magnetic material. In longitudinal media (also often referred as “conventional” media), the magnetization in the bits is flipped between lying parallel and anti-parallel to the direction in which the head is moving relative to the disc. Perpendicular magnetic recording media provide higher density recording as compared to longitudinal media. A thin-film perpendicular magnetic recording medium comprises a substrate and a magnetic layer having perpendicular magnetic anisotropy. In perpendicular media, the magnetization of the disc, instead of lying in the disc's plane as it does in longitudinal recording, stands on end perpendicular to the plane of the disc. The bits are then represented as regions of upward or downward directed magnetization (corresponding to the 1's and O's of the digital data).

One technology for meeting a demand of increasing the recording density of magnetic recording is heat assisted magnetic recording (HAMR). In HAMR, information bits are recorded on a data storage medium at elevated temperatures. In one HAMR approach, a beam of light is condensed to an optical spot on the storage medium to heat a portion of the medium and thereby reduce a magnetic coercivity of the heated portion. Data is then written to the reduced coercivity region.

In HAMR devices/systems, heating of the storage media may be carried out by, for example, applying radiant energy to the media from any suitable radiant energy source. Examples of radiant energy sources include continuous wave laser sources and pulsed laser sources that provide the radiant energy to the media by producing optical fields, which are directed at the media. Additional details are provided in commonly owned U.S. Pat. No. 11,127,419 for “Thermal Spot-Dependent Write Method and Apparatus for a Heat-Assisted Magnetic Storage Device,” which is hereby incorporated by reference.

Another technique to increase the areal density capacity of a data storage medium uses EAMR (energy-assisted magnetic recording), which sends a current through part of the writer to create a path for the magnetization flip of a media bit. Another method uses FC-MAMR (flux-control microwave-assisted magnetic recording) to direct more of the magnetic field flow to the writer.

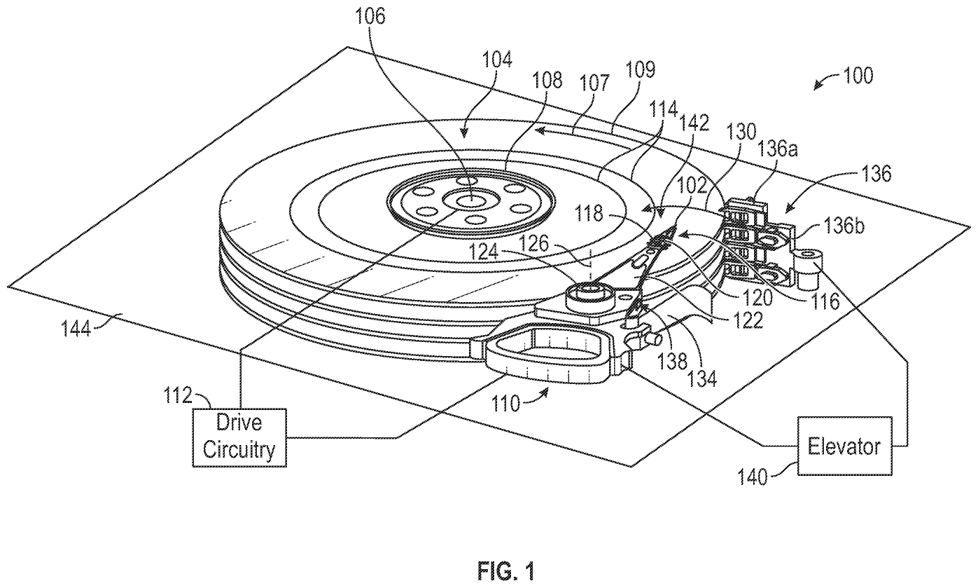

FIG. 1 shows an illustrative operating environment in which certain embodiments disclosed herein may be incorporated. The operating environment shown in FIG. 1 is for illustration purposes only. Embodiments of the present disclosure are not limited to any particular operating environment and can be practiced within any number of different types of operating environments.

It should be noted that the same reference numerals are used in different figures for the same or similar elements. All descriptions of an element also apply to all other versions of that element unless otherwise stated. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

It will be understood that, when an element is referred to as being “connected,” “coupled,” or “attached” to another element, it can be directly connected, coupled or attached to the other element, or it can be indirectly connected, coupled, or attached to the other element where intervening or intermediate elements may be present. In contrast, if an element is referred to as being “directly connected,” “directly coupled” or “directly attached” to another element, there are no intervening elements present. Drawings illustrating direct connections, couplings or attachments between elements also include embodiments, in which the elements are indirectly connected, coupled or attached to each other.

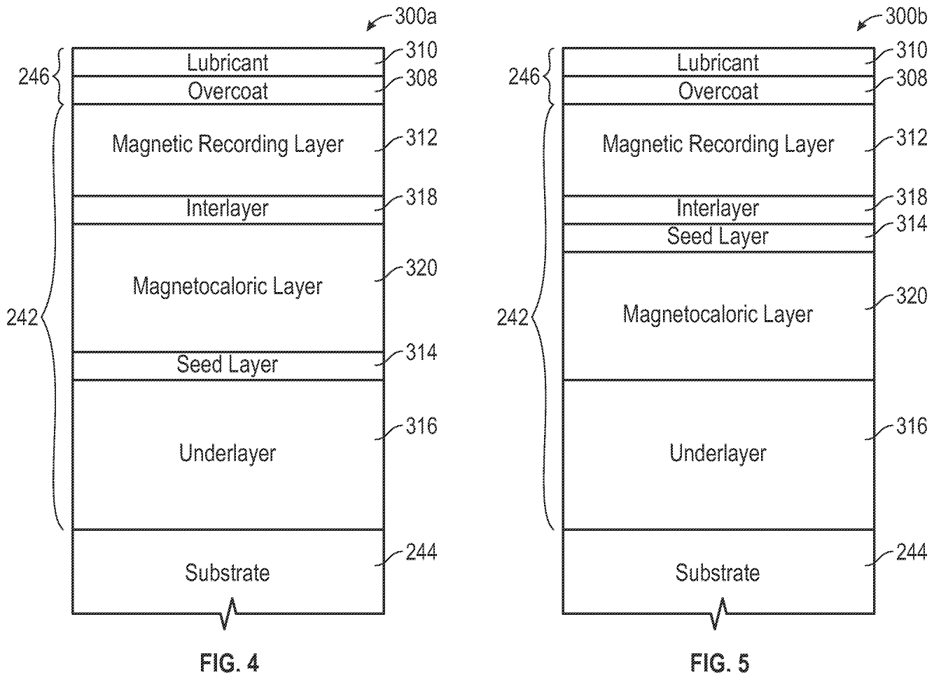

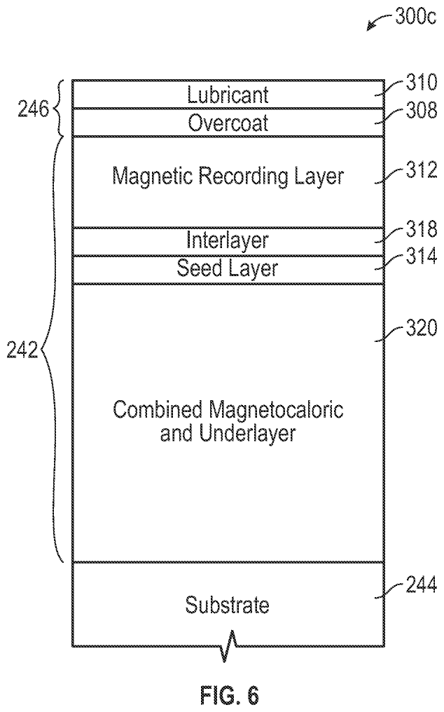

Three specific embodiments of a recording medium 300 are described, and in some cases they will be differentiated by referring to the first embodiment with reference number 300a (FIG. 4), the second embodiment with reference to number 300b (FIG. 5), and the third embodiment with reference to number 300c (FIG. 6). However, in many aspects, the structures are similar; descriptions of recording medium 300, 300a, 300b or 300c apply to all embodiments unless otherwise specified. This convention also applies to other similarly numbered elements. It is to be understood that these depictions are simplified, and a “layer” may actually comprise multiple layers of different materials.

As shown in FIGS. 4-6, exemplary magnetic recording media 300 comprise a magnetocaloric (MC) layer 320 between the magnetic recording layer 312 and the substrate 244. The MC layer 320 is made of a metal alloy and goes through a magnetic phase transition under the write footprint, which generates heats to heat up the magnetic recording layer 312, so the coercivity of the recording layer is temporarily reduced. This process helps improve writability. Immediately after writing, the MC layer 320 returns to its original magnetic state with removal of the magnetic write field. This process absorbs heat and therefore cools the recording layer 312, so the coercivity of the recording layer 312 is returned to its normal higher state, which strengthens the written bits and prevents signal jitter. Thus, the disclosed concepts require no extra steps during the writing process or heating devices in the recording head 230 for increased areal density capability (ADC). While illustrations of the medium 300 show substrate 244 on the bottom, with storage portion 242 above the substrate 244, it should be understood that a data storage disc can also be formed with a read/write surface on another side of the disc, so that the storage portion 242 is below substrate 244, to be used with a recording head 230 located below the disc.

FIG. 1 is a schematic illustration of a data storage device (DSD) 100 including data storage disc 104, a slider 102 carrying heads for reading data from and/or writing data to the data storage disc 104, and a ramp 136 for supporting a suspension load beam 120 that supports the slider 102. In the embodiment shown in FIG. 1, the data storage disc 104 are rotatable data storage discs stacked on spindle 106, with each disc 104 having opposing surfaces that serve as data storage medium surfaces. For read and write operations, a spindle motor rotates the disc 104 as illustrated by arrow 107, and actuator mechanism 110 positions the slider 102 relative to data tracks 114 on the rotating disc 104 between an inner diameter (ID) 108 and an outer diameter (OD) 109. Both the spindle motor and actuator mechanism 110 are connected to and operated through drive circuitry 112 (schematically shown). The actuator mechanism 110 may have a voice coil motor, for example.

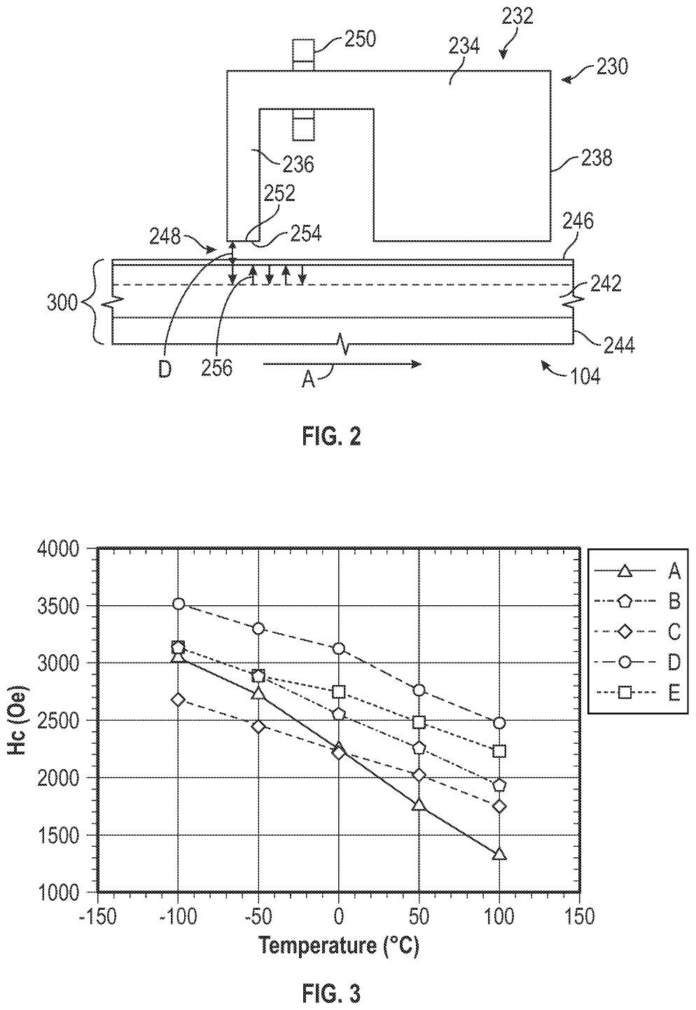

The actuator mechanism 110 is rotationally coupled to a frame or base deck 144 through a pivot shaft 124 to rotate actuator arm 122 about longitudinal axis 126 of shaft 124. The head gimbal assembly (HGA) 116 has an attachment structure 118 configured to the connect load beam 120 to the actuator arm 122. Air bearing slider 102 is carried by load beam 120 and includes one or more transducer elements, such as a recording head 230 (FIG. 2), coupled to head circuitry through flex circuit 134. The actuator mechanism 110 moves the slider 102 in a cross-track direction as illustrated by arrow 130. In an exemplary embodiment, slider 102 is aerodynamically designed to fly on an advanced air bearing (AAB) 248 that is created adjacent to the disc surface during disc rotation (see FIG. 2).

In general, in order to prevent slider 102 from landing on discs 104 in a data storage device 100 when, for example, power is removed from the data storage device 100, and to prevent the slider 102 from colliding with outer edges of the discs 104 during load and unload operations, a head support ramp assembly 136 is provided adjacent to the OD 109 of the discs 104.

In the illustrated embodiments, the air bearing slider 102 for carrying the read/write heads is depicted as being positioned above a storage medium surface of disc 104. However, it is to be understood that an actuator arm can also carry a load beam that has a slider with read/write heads that face upward from the load beam, in a configuration that allows the heads to read and write data relative to a data surface of a disc 104 that is positioned above the load beam 120.

In an exemplary embodiment in which the number of sliders 102 is fewer than a number of data surfaces of disc 104, actuator arm 122 may be moved in a z direction (along axis 126 of shaft 124) to different height positions under the motive of elevator 140, which is schematically shown in FIG. 1. Thus, a single head stack assembly 138 having HGA 116 can be moved to place its slider 102 in position to read and write data from any of the discs 104 of the stack of data storage discs. In general, any suitable driving mechanism may be used to move elevator 140 up and down. Exemplary drivers for Z-direction motion of elevator 140 include a ball screw with an internal motor, a voice coil motor, an inchworm style brake crawler, a linear motor, a shape memory alloy based actuator, and a combination of the above.

When the read/write heads 230 of a slider 102 are not actively in use for data transfer operations, the actuator mechanism 110 can be activated to rotate the actuator arm 122 in order to place a lift tab of load beam 120 on head support ramp assembly 136. Head-support ramp assembly 136 in some embodiments is designed as a split ramp with a stationary portion 136a and moveable portion 136b. With a lift tab of load beam 120 supported on the moveable ramp 136b, the paired actuator arm 122 and the moveable portion 136b can be moved in unison along axis 126 (such as vertically or in a z-direction) by the operationally connected elevator 140. In some embodiments, an entire ramp 136 or a portion thereof can also be moved in the x-y plane off the disc stack, such as by retraction, flexing, or rotation, for example.

While the illustrated environment of FIG. 1 depicts a DSD with a rotary actuator mechanism 110, it is to be understood that the disclosed concepts can also be practiced in a DSD having a linear driver for the actuator arm, such as described in commonly owned U.S. Pat. No. 11,348,611 for “Zero Skew Elevator System,” and in commonly owned U.S. Pat. No. 11,361,787 for “Zero Skew Disc Drive with Dual Actuators,” and in commonly owned U.S. Pat. No. 11,430,472 for “Triple Magnet Linear Actuator Motor,” and in commonly owned U.S. Pat. No. 11,488,624 for “Ball Bearing Cartridge for Linear Actuator,” which are hereby incorporated by reference.

FIG. 2 is a schematic side view of a perpendicular magnetic recording head 230 and a perpendicular magnetic storage medium 300 constructed in accordance with certain embodiments. In this example, the recording head 230 includes a magnetic write head 232 that includes a yoke 234 that joins a write pole 236 and a return pole 238. The recording head 230 is positioned adjacent to the perpendicular magnetic storage medium 300 having a storage portion 242 supported by a substrate 244. A bearing (for example, an active air bearing) 248 separates the recording head 230 from the storage medium 300 by a distance D. A coil 250 is used to control the magnetization of the yoke 234 to produce a write field at an end 252 of the write pole adjacent to a bearing surface 254 of the write head 232. The recording head 230 can also include a read head, which is not shown in the interest of simplification.

The perpendicular magnetic storage medium 300 is positioned adjacent to or under the recording head 230 and travels in the direction of arrow A. Storage portion 242 may include one or more magnetic layers that are deposited over the substrate 244. Substrate 244 may be made of any suitable material such as glass composite or aluminum. In some embodiments, the storage portion 242 may include both soft and hard magnetic layers. A soft magnetic layer may be made of any suitable material such as alloys or multiple layers having Co, Fe, Ni, Pd, Pt and/or Ru, for example. In some embodiments, a hard magnetic recording layer is deposited on the soft magnetic layer. In such embodiments, perpendicular magnetic domains 256 are contained in the hard magnetic layer. Suitable hard magnetic materials for the hard magnetic recording layer may include at least one material selected from, for example, CoCrPt or other cobalt-based alloys having a relatively high anisotropy at ambient temperature. A top coat 246 is included over the storage portion 242.

In magnetic recording, the magnetic switching or overwriting field (H) is a function of the write current (WC) and head media spacing (HMS). Generally, H needs to be higher than the coercivity (H_{c}) of the media recording layer for effective writability. Thus, improved writability can be achieved by increasing the switching field H by increasing the write current and/or reducing the head media spacing. Additionally or alternatively, improved writability can be obtained by reducing the media coercivity H_{c}. The media 300 of the current disclosure achieves reduced media coercivity during the writing process by heating the magnetic recording layer 312 to a higher temperature. The coercivity He of a cobalt-based magnetic recording layer is inversely proportional to temperature; the higher the temperature, the lower the coercivity, as illustrated in FIG. 3, for example.

FIG. 3 is a graph showing the nearly linear relationship between the coercivity of various thickness of a cobalt-based magnetic medium (specifically CoCrPt on a Cr underlayer) as a function of its temperature. This graph comes from the article by Tao Pan et al., “Temperature dependence of coercivity in Co-based longitudinal thin-film recording media,” J. Appl. Phys. 81 (8), 15 Apr. 1997. Specific information on each of these labeled samples is shown in Table 1:

TABLE 1
Switching volumes and dH_{c}/H_{c}dT of
different thickness CoCrPt media.

| Medium | KᵤV/k_{B}T | dH_{c}/H_{c}dT (%/° C.) | Sample |
|---|---|---|---|
| CoCrPt (100 Å)/Cr (1000 Å) | 89 | 0.50 | A |
| CoCrPt (200 Å)/Cr (1000 Å) | 210 | 0.27 | B |
| CoCrPt (400 Å)/Cr (1000 Å) | 317 | 0.23 | C |
| CoCrPt (600 Å)/Cr (1000 Å) | 404 | 0.23 | D |
| CoCrPt (800 Å)/Cr (1000 Å) | 408 | 0.21 | E |

In embodiments of the disclosure shown in FIGS. 4-6, the storage medium 300 is formed with a magnetocaloric (MC) 320 layer under a cobalt-based magnetic recording layer 312. During a write operation, the magnetic write pole 236 applies a magnetic field to the medium 300 for writing data in the magnetic recording medium 300. The magnetic field directed to the medium 300 causes the MC layer 320 to undergo a paramagnetic (PM) to ferromagnetic (FM) phase transition, which generates heat. This heat is absorbed by the magnetic recording layer 312. Higher temperature reduces the coercivity of the magnetic layer 312 temporarily and improves the media's writability. The change in coercivity may raise the temperature of the medium 300 from ambient temperature to approximately 100° C., for example. Thus, a localized area of the recording layer 312 is heated to lower its coercivity simultaneously with the write pole 236 applying a magnetic write field to that area of the recording medium 300. A medium 300 of the current disclosure thereby allows for high areal density capability (ADC) while limiting superparamagnetic instabilities that may occur with high coercivity recording media. When the magnetic field is removed, the MC layer 320 returns to its original state and absorbs the heat from its surroundings.

FIG. 4 is a diagrammatic illustration of a first embodiment of an exemplary data storage medium 300a. Top coat 246 in an exemplary embodiment comprises lubricant film 310 and protective overcoat 308. Lubricant film 310 may comprise perfluoropolyether (PFPE) or any other suitable material. In an exemplary embodiment, a diamond-like carbon overcoat 308 is provided for increased durability, anti-friction, anti-corrosion. In another embodiment, to minimize medium light reflectivity, a refractive index value of the carbon overcoat 308 is matched to a refractive index value the magnetic recording layer 312. This may be carried out by carefully tuning the composition, thickness, reflectivity of the carbon overcoat 308. Additional details are provided in commonly owned U.S. Pat. No. 10,643,648 for “Anti-Reflection Data Storage Medium,” which is hereby incorporated by reference.

In an exemplary embodiment, the lubricant film 310 is provided by dip coating onto the surface of carbon overcoat 308 to provide a reliable head disc interface. In an exemplary embodiment, the lubricant film 310 has a thickness of about 2 nanometers or less. In an exemplary embodiment, the carbon overcoat 308 has a thickness of about 2.5 nanometers or less.

In an exemplary embodiment, storage portion 242 comprises magnetic recording layer 312, interlayer 318, magnetocaloric layer 320, seed layer 314, and underlayer 316. In an exemplary embodiment, the magnetic recording layer 312 is made of a ferromagnetic (e.g., hard magnetic material), and cobalt-based alloys are particularly suitable, including CoCr alloys such as CoCrPtB, CoCrPt/Cr, CoCrTa/Cr, CoPt, for example. In an exemplary embodiment, magnetic recording layer 312 has a thickness of about 20 nanometers or less and a relatively high coercivity of about 3-8 kOe.

In an exemplary embodiment, interlayer 318 comprises one or more layers of non-magnetic materials such as ruthenium and/or chromium alloys and serves to promote desired microstructural and magnetic properties of the magnetic recording layer 312, such as by controlling its crystallographic orientation, grain size, and grain distribution. In exemplary embodiments, because interlayer 318 is designed to tune the properties of magnetic recording layer 312, interlayer 318 is positioned immediately adjacent magnetic recording layer 312. Additionally, interlayer 318 prevents exchange coupling between the soft underlayer 316 and the magnetic recording layer 312. In an exemplary embodiment, interlayer 318 is made of a metallic alloy has a thickness of about 10 nanometers or less. Additional details are provided in commonly owned U.S. Pat. No. 8,110,299 for “Granular Perpendicular Media Interlayer for a Storage Device,” which is hereby incorporated by reference.

Seed layer 314 may comprise MgO, Ta and Ta alloys, face-centered cubic (FCC) materials (such as Cu, Au, Ag), a nickel based FCC phase alloy, or any other suitable non-magnetic material. Seed layer 314 is used to prepare and enhance crystal growth of the interlayer 318. In an exemplary embodiment, the seed layer 314 has a thickness of about 3 nanometers or less.

The soft magnetic underlayer 316 serves as a return path of the writer's magnetic flux. A soft magnetic material does not retain magnetism when the external magnetic field is removed. Exemplary materials that can be used to form the soft underlayer 316 include CoFe based alloys and a NiFe alloy (Permalloy). The soft underlayer 316 may have a thickness of about 100 nanometers or less.

An adhesion layer (not shown) may comprise NiAl, a Ti alloy, or any other suitable material and be positioned between the soft underlayer 316 and the substrate 244.

The substrate 244 may be formed of a non-magnetic material such as aluminum, glass, glass-ceramic, aluminum/NiP, metal alloys, plastic/polymer material, ceramic, glass-polymer, and/or composite materials and can have a thickness of about one millimeter or less.

In exemplary embodiments of a data storage medium 300 of the present disclosure, a magnetocaloric layer 320 is disposed between the magnetic recording layer 312 and the substrate 244. For example, in medium 300a of FIG. 4, the magnetocaloric layer 320 is disposed between interlayer 318 and seed layer 314. In the storage medium 300b of FIG. 5, the magnetocaloric layer 320 is disposed between the seed layer 314 and the soft magnetic underlayer 316. And in the recording medium 300c shown in FIG. 6, the magnetocaloric layer 320 serves itself as the soft magnetic underlayer and is disposed between the seed layer 314 and the substrate 244.

Generally, the thicker the magnetocaloric layer 320, the more heat the MC layer can provide to the magnetic recording layer 312. Typically, in exemplary embodiments, the MC layer 320 has a thickness of at least about 30 nanometers, which is generally greater than the combined thicknesses of the magnetic recording layer 312 and the interlayer 318. Because the interlayer 318 and the seed layer 314 are relatively thin, the MC layer 320 can be spaced from the recording layer 312 by one or both of the interlayer 318 and the seed layer 314 and still have enough proximity to the magnetic recording layer 312 to provide sufficient heating for reducing its coercivity. In FIG. 6, the MC layer 320 serves two purposes since it is also made of a soft magnetic material. It serves as the return path of the writer's magnetic flux and also as the heating source for the magnetic recording layer 312.

The MC layer 320 has a magnetothermodynamic phenomenon in which the material heats up when a magnetic field is applied. Thus, when a magnetic field is applied by the write pole 236 to the recording medium 300, the MC layer 320 heats as it undergoes a phase change, and that heat is conveyed to the magnetic recording layer 312, such as through conduction, for example. Thus, the MC layer 320 locally heats the magnetic recording layer 312 at the location of the write operation to reduce the coercivity of the magnetic recording layer 312 temporarily and thereby improve the media's writability. When the magnetic field is removed, such as by motion of the medium 300 in direction A as shown in FIG. 2, the MC layer 320 returns to its original state and absorbs the heat from its surroundings.

In an exemplary embodiment, the MC layer 320 is formed by thin film deposition techniques. Many commercially available magnetocaloric materials are suitable including the following, for example: Ni—Mn-based alloys (Ni/Mn/In, Ni/Mn/Ca, Ni/Co/Mn/Ti, Ni_{2±x}Mn_{1±x}Ga alloys), Mn/As (such as MnAs₁₋ₓSbₓ compounds), La/Fe/Co/H, Bi/Co/Mn/Ti, Mn/Fe/Ni/Si/Al alloys, etc., which have relatively giant magnetocaloric effect. Other MC materials can also be: MnFeP(As, Ge, Si) alloys (such as MnFePₓAs₁₋ₓ and MnFePₓAs₍₁₋ₓ₎ alloys), Fe₂CoAl, Gd₅(SiₓGe₍₁₋ₓ₎)₄, Gd₅Si₂Ge₂, Gd₅(SiₓGe₄₋ₓ) alloys, La(Fe₁₋ₓSiₓ)₁₃ alloys and their hydrides La(Fe₁₋ₓSiₓ)₁₃H_{y}, La(FeₓSi₍₁₋ₓ₎)₁₃Hₓ and MnFeP(1-x)Asₓ alloys, etc.

The choice of material for MC layer 320 can also be guided by the location of the MC layer 320 in medium 300 and the presence or absence of other layers. For example, in the media 300a and 300b of FIGS. 4 and 5, the MC layer 320 is separate from the soft underlayer 316. In these embodiments, particularly suitable materials contain lanthanum (La) and Gadolinium (Gd): La(FeₓSi₍₁₋ₓ₎)₁₃Hₓ, Gd₅(SiₓGe₍₁₋ₓ₎)₄, Gd₅(SiₓGe₄₋ₓ) alloys, LaFeMnSi series (such as LaFe_{(11.71-x)}MnₓSi_{1.29}H_{1.6}), La(Fe₁₋ₓSiₓ)₁₃ alloys and their hydrides La(Fe₁₋ₓSiₓ)₁₃H_{y}, La/Fe/Co/H, Gd₅Si₂Ge₂, and so on. These MC materials usually have higher magnetocaloric effect.

In contrast, in the medium 300c of FIG. 6, the MC layer 320 serves a dual purpose as a heating layer as well as a soft magnetic underlayer. In this case, particularly suitable materials contain Ni and/or Fe, such as MnFeP₍₁₋ₓ₎Asₓ, MnFePₓAs₍₁₋ₓ₎, MnFeP(As,Ge,Si), Mn/Fe/Ni/Si/Al, Ni/Co/Mn/Ti, and so on. These MC materials are usually soft magnetic materials. In this embodiment, a thickness of the combined MC and underlayer 320 may be about 60 nanometers to about 100 nanometers.

Magnetization of recording medium 300 is induced by the writer's field and direction. Coercivity (H_{c}) represents how much of the head's magnetic field is needed to write the medium. The writer emits a certain magnetic switching or overwriting field (H); generally, H should be greater than twice the H_{c} of the medium. During a writing operation, the lower the H_{c} of the medium, the better the writability because then the magnetic grains can be switched easily. However, a balance must be obtained because lower media H_{c} also correlates with shorter data life. Thus, the disclosed embodiments lower the H_{c} during the writing operation for better writability, but allows the H_{c} of the medium to return to its higher state after the data is written for increased data life.

During a write operation, a strong magnetic field is transmitted by the write pole 236 to medium 300. The MC layer 320, at the area under the writer footprint, undergoes a paramagnetic to ferromagnetic phase transition, which results in a decrease of the magnetic entropy (ΔS). This phase transition generates heat that is conveyed upward to the magnetic recording layer 312, which absorbs the heat so that the temperature of the magnetic recording layer 312 increases (in some cases, a temperature increase of about 5° C. is sufficient). This increase in temperature of the cobalt-based magnetic recording layer 312 lowers its coercivity temporarily at the write footprint during the write operation, thus improving its writability. As the medium 300 moves out of the magnetic field with the written bits on the magnetic recording layer 312, the MC layer 320 absorbs heat to quickly cool down the recording layer 312, thereby maximizing writability and data life. This phenomenon minimizes jitter in the writing operation. Cooling of the magnetic recording layer 312 is enhanced by heat absorption of the MC layer 320 as it moves out of the magnetic field. These temperature changes occur very fast-on the order of nanoseconds.

Exemplary, non-limiting embodiments of a data storage medium and method of writing data are described. In an exemplary embodiment, a data storage medium 300 comprises a cobalt-based ferromagnetic recording layer 312, a non-magnetic substrate 244, and a magnetocaloric material 320. The magnetocaloric material 320 is disposed between the recording layer 312 and the substrate 244, wherein the magnetocaloric material 320 is configured to generate heat upon exposure to a magnetic field that causes a phase change in the magnetocaloric material 320.

In an exemplary embodiment, an interlayer 318 is disposed between the recording layer 312 and the magnetocaloric material 320. In an exemplary embodiment, a seed layer 314 is disposed between the interlayer 318 and the magnetocaloric material 320. In an exemplary embodiment, a thickness of the magnetocaloric material 320 is equal to or greater than a combined thickness of the interlayer 318 and the recording layer 312. In an exemplary embodiment, a soft magnetic underlayer 316 is disposed between the magnetocaloric material 320 and the substrate 244.

In an embodiment, the magnetocaloric material 320 comprises a soft magnetic material, and the magnetocaloric material 320 is disposed adjacent the substrate 244. In an exemplary embodiment, the magnetocaloric material 320 comprises an alloy selected from the group consisting of MnFeP₍₁₋ₓ₎Asₓ, MnFeP(As,Ge,Si), Mn/Fe/Ni/Si/Al, and Ni/Co/Mn/Ti. In some embodiments, the magnetocaloric material comprises an alloy selected from the group consisting of Ni/Mn/In, Ni/Mn/Ca, Ni/Co/Mn/Ti, Mn/As, La/Fe/Co/H, Bi/Co/Mn/Ti, Mn/Fe/Ni/Si/Al, MnFeP(As, Ge, Si), Fe₂CoAl, Gd₅(SiₓGe₍₁₋ₓ₎)₄, La(FeₓSi₍₁₋ₓ₎)₁₃Hₓ, MnFeP₍₁₋ₓ₎Asₓ, La/Fe/Mn/Si and La/Fe/Co/H.

In another embodiment, a method of writing data onto a data storage medium 300 comprises applying a magnetic field to the data storage medium 300 at a write location from a write head 232, wherein the data storage medium 300 comprises a cobalt-based ferromagnetic recording layer 312, a non-magnetic substrate 244, and a magnetocaloric material 320 disposed between the recording layer 312 and the substrate 244. The magnetocaloric material 320 generates heat upon exposure to the magnetic field that causes a phase change in the magnetocaloric material 320. The method comprises transferring heat from the magnetocaloric material 320 to the recording layer 312; moving the write location out of the magnetic field (such as in direction A), wherein the phase change is reversed; and absorbing heat from the recording layer 312 by the magnetocaloric material 320.

In an exemplary embodiment, transferring heat comprises raising a temperature of the recording layer 312 at the write location by about 5° C. to about 150° C. In an exemplary embodiment, transferring heat comprises raising a temperature of the recording layer 312 at the write location by about 50° C. to about 100° C.

In an exemplary embodiment, an interlayer 318 disposed between the recording layer 312 and the magnetocaloric material 320 improves the desired crystallographic orientation of the recording layer 312. In an exemplary embodiment, transferring heat comprises conveying the heat from the magnetocaloric material 320, through the interlayer 318, and to the recording layer 312.

In an exemplary embodiment, a seed layer 314 disposed between the interlayer 318 and the magnetocaloric material 320 affects crystal growth of the interlayer 318. In an exemplary embodiment, transferring heat comprises conveying the heat from the magnetocaloric material 320, through the seed layer 314, through the interlayer 318, and to the recording layer 312. In an exemplary embodiment, a return path of the magnetic field to the write head 232 is directed through the magnetocaloric material 320.

The illustrations of the embodiments described herein are intended to provide a general understanding of the structure of the various embodiments. The illustrations are not intended to serve as a complete description of all of the elements and features of apparatus and systems that utilize the structures or methods described herein. Features described with respect to any embodiment also apply to any other embodiment. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description. All patent documents mentioned in the description are incorporated by reference.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all modifications, enhancements, and other embodiments, which fall within the scope of the present disclosure. For example, features described with respect to one embodiment may be incorporated into other embodiments. Thus, to the maximum extent allowed by law, the scope of the present disclosure is to be determined by the broadest permissible interpretation of the following claims and their equivalents, and shall not be restricted or limited by the foregoing detailed description.

1. A data storage medium comprising:
a cobalt-based ferromagnetic recording layer;
a non-magnetic substrate; and
a magnetocaloric material disposed between the recording layer and the substrate, wherein the magnetocaloric material is configured to generate heat upon exposure to a magnetic field that causes a phase change in the magnetocaloric material.

2. The data storage medium of claim 1 comprising an interlayer disposed between the recording layer and the magnetocaloric material.

3. The data storage medium of claim 2 comprising a seed layer disposed between the interlayer and the magnetocaloric material.

4. The data storage medium of claim 2, wherein a thickness of the magnetocaloric material is equal to or greater than a combined thickness of the interlayer and the recording layer.

5. The data storage medium of claim 1 comprising a soft magnetic underlayer disposed between the magnetocaloric material and the substrate.

6. The data storage medium of claim 1, wherein:
the magnetocaloric material comprises a soft magnetic material; and
the magnetocaloric material is disposed adjacent the substrate.

7. The data storage medium of claim 6, wherein the magnetocaloric material comprises an alloy selected from the group consisting of MnFeP₍₁₋ₓ₎Asₓ, MnFeP(As,Ge,Si), Mn/Fe/Ni/Si/Al, and Ni/Co/Mn/Ti.

8. The data storage medium of claim 1, wherein the magnetocaloric material comprises an alloy selected from the group consisting of Ni/Mn/In, Ni/Mn/Ca, Ni/Co/Mn/Ti, Mn/As, La/Fe/Co/H, Bi/Co/Mn/Ti, Mn/Fe/Ni/Si/Al, MnFeP(As, Ge, Si), Fe₂CoAl, Gd₅(SiₓGe₍₁₋ₓ₎)₄, La(FeₓSi₍₁₋ₓ₎)₁₃Hₓ, MnFeP₍₁₋ₓ₎Asₓ, La/Fe/Mn/Si and La/Fe/Co/H.

9. A method of writing data onto a data storage medium, the method comprising:
applying a magnetic field to the data storage medium at a write location from a write head,
wherein the data storage medium comprises:
a cobalt-based ferromagnetic recording layer;
a non-magnetic substrate; and
a magnetocaloric material disposed between the recording layer and the substrate;
wherein the magnetocaloric material generates heat upon exposure to the magnetic field that causes a phase change in the magnetocaloric material;
transferring heat from the magnetocaloric material to the recording layer;
moving the write location out of the magnetic field, wherein the phase change is reversed; and
absorbing heat from the recording layer by the magnetocaloric material.

10. The method of claim 9, wherein transferring heat comprises raising a temperature of the recording layer at the write location by about 5° C. to about 150° C.

11. The method of claim 9, wherein transferring heat comprises raising a temperature of the recording layer at the write location by about 50° C. to about 100° C.

12. The method of claim 9, comprising affecting a crystallographic orientation of the recording layer with an interlayer disposed between the recording layer and the magnetocaloric material.

13. The method of claim 12, wherein transferring heat comprises conveying the heat from the magnetocaloric material, through the interlayer, and to the recording layer.

14. The method of claim 12, comprising affecting crystal growth of the interlayer by a seed layer disposed between the interlayer and the magnetocaloric material.

15. The method of claim 14, wherein transferring heat comprises conveying the heat from the magnetocaloric material, through the seed layer, through the interlayer, and to the recording layer.

16. The method of claim 9, wherein the magnetocaloric material comprises an alloy selected from the group consisting of Ni/Mn/In, Ni/Mn/Ca, Ni/Co/Mn/Ti, Mn/As, La/Fe/Co/H, Bi/Co/Mn/Ti, Mn/Fe/Ni/Si/Al, MnFeP(As, Ge, Si), Fe₂CoAl, Gd₅(SiₓGe₍₁₋ₓ₎)₄, La(FeₓSi₍₁₋ₓ₎)₁₃Hₓ, MnFeP₍₁₋ₓ₎Asₓ, La/Fe/Mn/Si and La/Fe/Co/H.

17. The method of claim 9, wherein a return path of the magnetic field to the write head is directed through the magnetocaloric material.

18. The method of claim 17, wherein the magnetocaloric material comprises an alloy selected from the group consisting of MnFeP₍₁₋ₓ₎Asₓ, MnFeP(As,Ge,Si), Mn/Fe/Ni/Si/Al, and Ni/Co/Mn/Ti.
